(19) United States
(12) Patent Application Publication
(10) Pub. No.: US 2018/0253487 A1
(43) Pub. Date: Sep. 6, 2018

(54) PROCESSING A HELP DESK TICKET

(71) Applicant: INTERNATIONAL BUSINESS MACHINES CORPORATION, Armonk, NY (US)

(72) Inventors: Francesco M. Carteri, Roma (IT); Fabio Cerri, Roma (IT); Giuseppe Ciano, Roma (IT); Marco De Santis, Roma (IT); Alessandro Scotti, Roma (IT)

(21) Appl. No.: 15/450,902

(22) Filed: Mar. 6, 2017

(51) Int. Cl. G06F 17/30

(52) U.S. Cl. CPC G06F 17/30699; G06F 17/30654

(57) ABSTRACT

A method for processing a help desk ticket comprising a problem description is provided. The method includes receiving the ticket submitted by a user of a help desk system. A skill level of the user may be determined from user profile data accessible to the help desk system. The skill level describes the user's skill related to a predefined topic. At least one topic may be determined based on the problem description. Candidate solutions may be retrieved from at least one information system based on the problem description; and the candidate solutions may be filtered and/or ranked based on matching the determined topic and the user's skill level. An associated computer system and computer program product is also provided.

### TECHNICAL FIELD

The present invention relates to the field of digital computer systems, and more specifically, to a method for processing a help desk ticket comprising a problem description.

### BACKGROUND

Users have a daily engagement with the internet, and in particular with social media. When users experience a technical problem of any type, (e.g. a laptop display issue), users tend to leverage the user's knowledge of the web, and use the web to spread the user's problem and get information about the issue. There is however a continuous need to improve the user interaction with social media, in particular as the number of users and technical issues is increasing.

### SUMMARY

An aspect of this invention relates to a method and associated computer system and computer program product for processing a help desk ticket comprising a problem description. A processor of a computing system receives the help desk ticket submitted by a user of a help desk system. A skill level of the user is determined from user profile data accessible to the help desk system, the skill level describing the user's skill related to a predefined topic. At least topic is determined based on the problem description. A plurality of candidate solutions is retrieved from at least one information system based on the problem description. The plurality of candidate solutions are filtered and/or ranked based on matching the predefined topic and the skill level of the user.

### BRIEF DESCRIPTION OF THE DRAWINGS

FIG. 1 depicts a block diagram of a computerized help desk system, in accordance with embodiments of the present invention.

FIG. 2 depicts a flowchart of a method for processing a help desk ticket comprising a problem description, in accordance with embodiments of the present invention.

FIG. 3 depicts a block diagram of a method for processing a help desk ticket comprising a problem description, in accordance with embodiments of the present invention.

### DETAILED DESCRIPTION

Users have a profile that comprises a ranking of the user's skill about various topics (e.g. Security, Operating Systems, Networking, Mobile . . . ), which may be built from a history of the activities of the user in a help desk system and/or from available ranking systems, such as forums, discussion groups, tech blogs, job role, etc. Issues reported in the help desk system are analyzed and classified by topic. Similarly, solutions are classified by topic and a ranking is assigned to the solutions. When searching for a solution, the help desk system matches the topic and the user's skill on that topic, in order to tailor the result set (i.e. comprising the solutions) according to the user skill. If no satisfactory solutions are found at all, the help desk system impersonates a real user and posts a question about the same topic at the same expertise level on the registered external sources (i.e. same as above, forum, Stack Overflow, etc.).

The determining of the at least one topic may be performed using a cognitive service. For example, the cognitive service may identify, and extract contextual elements such as meaning, syntax, time, location, appropriate domain, regulations, process, task and goal from the problem description. The cognitive service may draw on multiple sources of information, including both structured and unstructured digital information, as well as sensory inputs (e.g. visual, gestural, auditory, or sensor-provided).

The problem description may indicate a technical problem, such as a system performance problem or application performance problem, including a database performance problem, etc. The problem description may be a data structure comprising one or more fields each representing an attribute, wherein the attribute is a parameter indicative of the problem. The parameter may comprise at least one of: a problem category; a time frame of problem occurrence or other information indicative of the problem, etc.

Embodiments of the present method may have the advantage of providing a reliable technique for solving technical problems by reducing the number of user interventions to a minimum. Thus, even very unexperienced users may solve very complex technical issues without even having technical domain knowledge at all using the present method.

Embodiments of the present invention also relate to a system and an algorithm that is able to interact with users by means of modern internet channels (e.g. social media) in order to:

acquire and record the knowledge the users accumulated while investigating or solving the issues;

evaluate the quality of the work done by the same help desk system by analyzing the sentiment status of users from social media (e.g. frustration for the silly solutions proposed etc.); and

automatically and proactively interact with users in order to get information being relevant to solve issues or to evaluate the user's sentiment (e.g. a solution can be asked in a specialized forum by the help desk system itself).

Embodiments of the present method finds information and engages users on social media channels to collect data about topics and users related to open issues; and the help desk system maintains such information for further actions and processing. The social media used by the help desk system are selected relying on a cognitive and analytics processing of the social activities of the users, on the raking assigned by the help desk system to each social media entity involved in the problem resolution, and on the help desk system's hot topics (e.g. open and historical issues).

The help desk system may impersonate a real user with an active account on social media, such that the help desk system may interact with other users in order to collect relevant information for the help desk system. For example, the help desk system can add comments to detect the sentiment of the users about specific topics, or can ask questions to a blog of experts to get a solution for an issue.

The help desk system may rank entities of the algorithm (e.g. users, topics and social media) based on various rankings inputs coming from different contexts such as the open issues in the help desk system, the user ranking in a blog, the number of users subscribed to the blog or a media, the type of the media, the activities in the help desk system etc.

Social media or social network are computer-mediated technologies that allow the creating and sharing of information, ideas, problems, career interests and other forms of expression via virtual communities and networks. Social media may refer to a web-site on which one or more users may post content related to social interaction on a web-site. Content generally refers to images, videos, comments or other text, date information, identification data, links, user profiles, or other data or information that may be posted or otherwise accessible on or from the social media site(s). Examples of social media websites are FACEBOOK, WHATSAPP, TUMBLR, INSTAGRAM, TWITTER, BAIDU TIEBA, PINTEREST, LINKEDIN, GAB, GOOGLE+, YOUTUBE, VIBER, SNAPCHAT, WEIBO, WECHAT, and blogs.

The term “solution” refers to content indicating proposals to solve a problem. The solution may be provided in the form of a computer file, article, product designs, terms, images, symbols, one or more social media notifications, conversations, message threads, e-mails, text messages, instant messages, or any other electronic communications etc.

According to an exemplary embodiment, the information system includes a local database of the help desk system and/or at least one social network. By using multiple solution sources, this embodiment may increase the probability of solving the problem, and thus may reduce the interaction time of the user with the help desk system that would otherwise be longer in case of multiple adapted searches in a single source.

According to an exemplary embodiment, the retrieving of the candidates solutions comprises logging in to the information system using a user account in the help desk of the user. Using the same login account for reporting a problem as well as for accessing sources of the solutions may save processing resources that would otherwise be required for manipulating and/or generating multiple login accounts for the same user.

According to an exemplary embodiment, the method further comprises reading the user profile data for identifying the information system and performing the retrieving from the identified information system, which may assign to each user the corresponding solution. For example, if a user is used to accessing certain kind of blogs, such as software blogs, using the blogs as a source of solutions may increase the probability of finding the solution that is convenient for the skill level of the user because the user is used to reading and accessing the blogs, which may further save processing resources that would otherwise be required for accessing other sources that may provide solutions which are not convenient for the skill level of the user. The information systems may be useful to find solutions not only for the user but also for users having similar skill with respect to the topic.

The user profile data may comprise the description of the characteristics of the user, which can be exploited by the help desk system taking into account the users' characteristics and preferences.

According to an exemplary embodiment, the method further comprises mapping multiple information systems with respective topics, and selecting the information system based on the determined topic using the mapping, which may speed up the search of the solutions by searching only the right sources of solutions, which may thus save processing resources.

According to an exemplary embodiment, the filtering of the candidate solutions comprises: deciding, using the information system, whether each of the candidate solutions has a positive or a negative sentiment; filtering candidate solutions having positive sentiments; and performing the ranking on the filtered candidate solutions. By excluding the solutions which are lowly rated (e.g. negative sentiment), this embodiment may increase the performance of the present method in that the solutions that are presented to the user are most likely the best ones or the right ones.

The sentiment of a solution may be determined using a sentiment analysis. A “sentiment” refers to an attitude, opinion, or judgment of a human with respect to a subject.

Sentiment analysis or opinion mining refers to the use of natural language processing, text analysis and computational linguistics to identify and extract subjective information in source data. For example, a sentiment analysis system may use different approaches such as a NLP-based method that analyzes the language using natural language processing tools, statistical machine learning-based methods that use classifiers (e.g. Bayes classifiers); or Lexicon based methods that use a lexicon of opinion terms, called opinion lexicon, which contains the set of at least positive and negative terms.

Sentiment analysis aims to determine the attitude of a speaker or a writer with respect to some topic or the overall contextual polarity of a document. The attitude may be his or her judgment or evaluation, the emotional state of the author when writing, or the emotional effect the author wishes to have on the reader.

Sentiment analysis involves identifying each term appearing in the messages and assigning a score to the term, which can be a negative score or positive score to express whether the term is associated with negative sentiment, or positive sentiment.

A “term” refers to a word or a combination of words for which a sentiment can be expressed. As examples, a term can be a noun or compound noun. As other examples, a term can be any other word or combination of words that an analyst wishes to consider, where the word(s) can be a noun, a compound noun, an adjective, a verb, and so forth. Sentiment or opinion words in the messages can also be identified, where sentiment words include individual words or phrases made up of multiple words that express an attitude, opinion, or judgment of a human. Examples of sentiment words include “bad,” “poor,” “great performance,” “fast service,” and the like.

According to an exemplary embodiment, the retrieving of the candidate solutions is performed from respective users of the social network or social media, wherein the ranking of the candidate solutions is based on evaluated users' skill levels at the social network of the users. The users on social networks may be rated by other users based on the solutions that the users provide. A solution that is received from a highly ranked user is most likely to be the right one. Thus, a classification of the solutions based on the source of the solution, namely, the user who provided the solution, enables an optimal classification which would further increase the probability of providing the best or right solution to the user.

According to an exemplary embodiment, the information system includes a local database of the help desk system and/or at least one social network or social media, the method further comprising: ranking the social networks based on the number of user accounts in the social networks, and selecting the first ranked social network, wherein the retrieving is performed from the local database and/or the selected social network. Using highly ranked or used social media further increase the probability of providing the best or right solution to the user.

According to an exemplary embodiment, the information system includes at least one social network and wherein the method comprises: evaluating the quality of at least one of the candidate solutions; and if a result of the evaluating is that the quality is insufficient, then submitting a machine generated request comprising the problem description to a social network and retrieving a response to the request posted on the social network. In other terms, the candidate solutions may be first retrieved from an internal database of the help desk system and if the candidate solutions' quality is insufficient, the social network may be used to provide solutions. For example, the forums or social media may provide API access to the data to support requests, such as the machine generated request. The interaction of the help desk system with external forums or social media can be done, for example, using bot technology. The quality of a solution may be provided based on a user rating of the solution. For instance, the solutions of a blog are rated by the users of the blog, and the rating of the solutions rating may indicate the quality of the solutions.

According to an exemplary embodiment, the skill level is further determined from information retrieved from at least one reputation system, for example from an online forum where the user's skill related to the predefined topic is evaluated, which may enable an accurate definition of the user's skill which may further increase the probability of providing the right solution to the problem raised by the user.

According to an exemplary embodiment, the ranking of the candidate solution is performed using a ranking of the information system. For example, the higher or lower the ranking of the information system, the higher or lower the ranking of the solution may be. Assuming, for example, that the user asks, “how to recover data on a damaged hard disk,” and suppose that two information systems are to be used for that topic. The two information systems may comprise:
an internal system knowledge base which has some articles done over the years to help users to recover certain issues with the hard drive but the internal system knowledge base is bound to limited cases and platforms. The internal system knowledge base has been considered as ‘not so good’ to answer such type of questions and the internal system knowledge base is ranked or has a score of 50/100 with respect to this topic (i.e. hard disk issues), and
an external blog, (e.g. Tom's Hardware), which is specialized in answering questions about computer issues and the external blog has an associated score of 80/100 as data source for this specific topic.

The retrieved solutions of the two information systems may comprise a first solution ranked 4/5 stars coming from the internal system knowledge base and a second solution ranked 4/5 coming from the external blog. In this case, the ranking of the retrieved solutions can be as follows:

First solution=4/5*50/100=0.4

Second solution=4/5*80/100=0.64

The first solution has a score of 40% while the second solution has a score of 64%, which provides a ranking of the two solutions.

In another exemplary embodiment, the ranking of a solution may be performed based on the skill level of the person or user that provided the solution. If, for example, the skill level of the user is “expert,” the solution provided from an expert person may be ranked first (i.e. highest rank), and a solution provided by normal skilled person may be ranked lower, and so on.

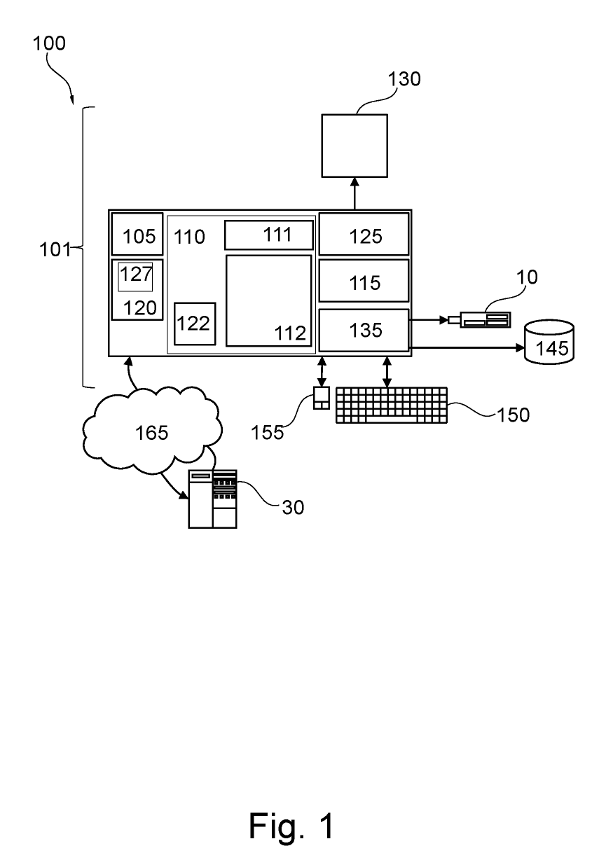

FIG. 1 depicts a block diagram of a computerized help desk system 100, in accordance with embodiments of the present invention. Embodiments of the system and methods described herein are at least partly non-interactive, and automated by way of computerized systems, such as servers or embedded systems. In exemplary embodiments, the methods described herein can be implemented in a (partly) interactive system, and can further be implemented in software 112, 122 including firmware 122, hardware (e.g. processor) 105, or a combination thereof. In exemplary embodiments, the methods described herein are implemented in software, as an executable program, and is executed by a special or general-purpose digital computer, such as a personal computer, workstation, minicomputer, or mainframe computer. The most general system 100 therefore includes a general-purpose computer 101.

In exemplary embodiments, in terms of hardware architecture, as shown in FIG. 1, the computer 101 includes a processor 105, memory (e.g. main memory) 110 coupled to a memory controller 115, and one or more input and/or output (I/O) devices or peripherals 10, 145 that are communicatively coupled via a local input/output controller 135. The input/output controller 135 can be, but is not limited to, one or more buses or other wired or wireless connections, as is known in the art. The input/output controller 135 may have additional elements, which are omitted for simplicity, such as controllers, buffers (e.g. caches), drivers, repeaters, and receivers, to enable communications. Further, the local interface may include address, control, and/or data connections to enable appropriate communications among the aforementioned components. As described herein the I/O devices 10, 145 may generally include any generalized cryptographic card or smart card known in the art.

The processor 105 is a hardware device for executing software, particularly that is stored in memory 110. The processor 105 can be any custom made or commercially available processor, a central processing unit (CPU), an auxiliary processor among several processors associated with the computer 101, a semiconductor based microprocessor (e.g. in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM). Note that the memory 110 can have a distributed architecture, where various components are situated remote from one another, but can be accessed by the processor 105.

The software in memory 110 may include one or more separate programs, each of which comprises an ordered listing of executable instructions for implementing logical functions, notably functions involved in embodiments of this invention. In the example of FIG. 1, software in the memory 110 includes instructions or software 112 (e.g. instructions to manage databases such as a database management system).

The software in memory 110 shall also typically include a suitable operating system (OS) 111. The OS 111 essentially controls the execution of other computer programs, such as possibly software 112 for implementing methods as described herein.

The methods described herein may be in the form of a source program 112, executable program 112 (e.g. object code), script, or any other entity comprising a set of instructions 112 to be performed. When a source program, then the program needs to be translated via a compiler, assembler, interpreter, or the like, which may or may not be included within the memory 110, so as to operate properly in connection with the OS 111. Furthermore, the methods can be written as an object oriented programming language, which has classes of data and methods, or a procedure programming language, which has routines, subroutines, and/or functions 002E.

In exemplary embodiments, a conventional keyboard 150 and mouse 155 can be coupled to the input/output controller 135. Other output devices such as the I/O devices 145 may include input devices, for example but not limited to a printer, a scanner, microphone, and the like. Finally, the I/O devices 10, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices 10, 145 can be any generalized cryptographic card or smart card known in the art. The system 100 can further include a display controller 125 coupled to a display 130. In exemplary embodiments, the system 100 can further include a network interface for coupling to a network 165. The network 165 can be an IP-based network for communication between the computer 101 and any external server, client, and the like, via a broadband connection. The network 165 transmits and receives data between the computer 101 and external systems 30, which can be involved to perform part or all of the steps of the methods discussed herein. In exemplary embodiments, network 165 can be a managed IP network administered by a service provider. The network 165 may be implemented in a wireless fashion (e.g., using wireless protocols and technologies, such as WiFi, WiMax, etc.) The network 165 can also be a packet-switched network, such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) 122. The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software 112 stored within the memory 110, to communicate data to and from the memory 110, and to generally control operations of the computer 101 pursuant to the software. The methods described herein and the OS 111, in whole or in part, but typically the latter, are read by the processor 105, possibly buffered within the processor 105, and then executed.

When the systems and methods described herein are implemented in software 112, as is shown in FIG. 1, the methods can be stored on any computer readable medium, such as storage 120, for use by or in connection with any computer related system or method. The storage 120 may comprise a disk storage such as HDD storage.

The storage 120 may comprise a knowledge base 127. Although the knowledge base 127 is shown as part of the storage 120, the knowledge base 127 may be stored in other storages that that can be accessed by the computer 101. For example, the knowledge base 127 may be stored on the external systems 30 or I/O devices 145.

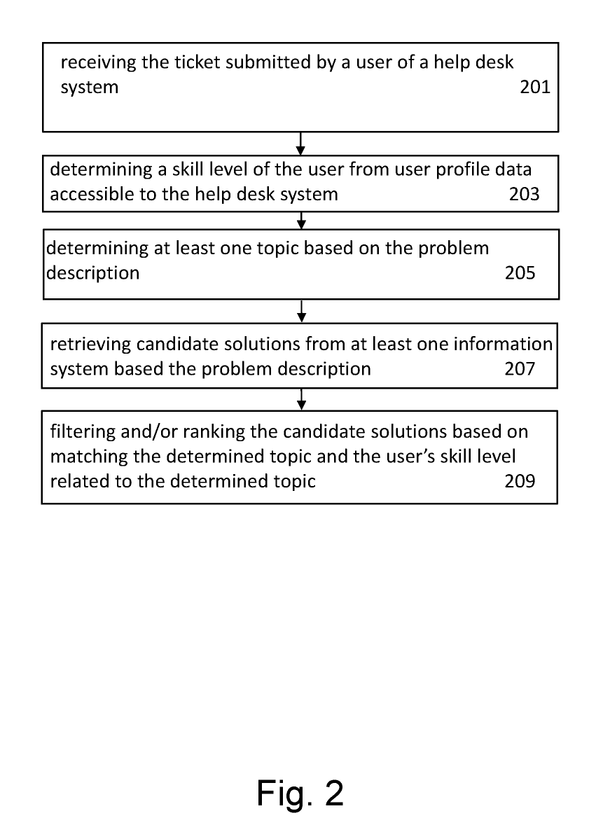

FIG. 2 depicts a flowchart of a method for processing a help desk ticket comprising a problem description, in accordance with embodiments of the present invention. The ticket comprises a problem description. The problem description may comprise information on the problem. For example, the problem may be a hardware and/or software problem.

In step 201, the ticket submitted by a user of a help desk system 100 may be received at the help desk system 100.

For example, in order to submit the ticket, the user may register to the help desk system 100 by passing various types of identity information, such as FACEBOOK Id, TWITTER ID, LINKED-IN ID, e-mail etc. of the user that are used as log in accounts in FACEBOOK, TWITTER, LINKED-IN and email server respectively. The identity information allows the help desk system 100 to associate the user in different internet contexts. The user may have a login account in the help desk system 100. The login account may be generated using the identity information. For example, the login account may be the FACEBOOK ID of the user.

The user may first login into the help desk system 100 and may open the ticket and submit the ticket describing the problem.

In an exemplary embodiment, the user may be classified or ranked (e.g. together with other users) using at least one of:

a number and a length of interactions of the user with the help desk system 100 (e.g. is the user collaborative in applying procedures?);

how frequent the user provides solutions already available in the help desk system 100;

job roles of the user, for example, for an IBM user, the job role can be derived from BluePages and information about the areas of expertise from the personal user history or awards;

a rating of the user in specific blogs;

areas of interest of the user, wherein the area of interest may be derived from the fact that the user is a registered user in a blog about specific IT topics (e.g. a blog specialized in Storage, or Video card etc.); and

a ranking of the user on a topic provided by other users or by the solutions used by the user, for example, external forums can be used to obtain a rank of the user on a specific topic from the ranking assigned in the forum; in another example, the ranking to a solution is transferred to the user when the user accepts the solution.

The classification or ranking of the user may result in assigning a rank to the user associated with respective topics. The rank may indicate that the user is a novice user, knowledgeable user, intermittent user, or an expert user. For example, the user may be ranked as “expert” in field of operating systems, such as LINUX.

The classification of the user may be performed upon receiving the ticket or may be performed as soon as the user has created a login account with the help desk system 100.

In step 203, a skill level of the user may be determined from user profile data accessible to the help desk system 100. The skill level describes the user's skill related to predefined one or more topics.

The user profile data may comprise data indicating the classification of the user. For example, if the user is classified as being a user providing too frequently solutions for LINUX system issues, the skill level may indicate that the user is an expert in the topic of LINUX.

For example, the level of expertise (i.e. skill level) for the user may be represented by an integer from 0 to 100. The rating of the user may be determined in a similar manner in which the rating of the solution is calculated (e.g. as an integer (0,100)) using cognitive technologies on the internal history of the actions taken into the system (example.g. opening tickets, posting or reviewing solutions) and on the external history in the configured external sources (LINKED-IN posts, STACKOVERFLOW questions/answers, etc.).

In step 205, at least one topic may be determined based on the problem description. For example, a knowledge base may be provided where topics are associated with terms describing a problem. The at least one topic may be determined by reading the knowledge base and matching the terms of the knowledge base with the problem description comprised in the received ticket.

In another example, step 205 may comprise prompting an agent of the help desk system 100 for providing the at least one topic based on the problem description of the received ticket. The determined topic may be an OS topic, computer network topic, hardware storage topic etc.

In another example, using cognitive computing techniques, the at least one topic of the problem description may be extracted.

In step 207, candidate solutions may be retrieved based on the problem description from at least one information system. The candidate solutions may be retrieved further based on the determined topic, which may limit the search of the candidate solutions to a smaller sample and may thus save processing resources.

The help desk system 100 searches for information or solutions on relevant company internal sources such as IBM Wikis, Collaborations, Communities, or external sources including social media channels such as STACKOVERFLOW, LINKED-IN, TECH BLOGS.

The information system may store the solutions in association with predefined problems. The predefined problems may be indicated in the information systems using keywords or terms describing the problems (e.g. “WiFi connection is unstable in phone type X”, “mobile application X is very slow”) by comparing the problem description of the received ticket with the stored keywords, solutions may be identified for the problem description of the received ticket.

The information system includes a local database (e.g. knowledge base 127) of the help desk system 100 and/or at least one social network or social media. In an exemplary embodiment, the retrieving of the candidate solutions comprises logging in to the information system using the login account of the user in the help desk system 100.

In an exemplary embodiment, the information system may be identified in the user profile data before performing the retrieval of the candidate solutions.

In an exemplary embodiment, a mapping of multiple information systems with respective topics may be provided, wherein the information system is selected using the determined topic and the mapping.

The information system may be used by the help desk system 100 as a data source to get and push information.

The information system may be a common social media. The help desk system 100 may be instrumented with a dedicated plug-in to impersonate an “automated user” that is able to register to the social media and use the “automated user” to browse or parse, capture and submit posts. For example, the common social media may provide or comprise the plug-in. In another example, the forums or social media may provide API access to the data to support APPs or to support access to the social media. The association of the user, topic, solution and the evaluation of the threshold can for example be managed using an analytic engine as mapReduce. The interaction of the help desk system 100 with external forums or social media can be done for example using bot technology.

Step 207 may be performed after classifying multiple information systems, wherein the information system from which the candidate solutions is retrieved is selected among based on the classification, which may speed up the solution search process and may further provide reliable solutions to the problem of the received ticket. The information system may be classified (e.g. with other information systems) by reputation and by context. For example, the information system may comprise a blog and may thus be classified based on the topics of the blog, wherein the classification may be advantageous as specialized blogs are effective when searching specific information (e.g. searching a storage blog for issues related to SAMSUNG solid state disk can be very effective respect to searching FACEBOOK).

In an exemplary embodiment, the information system may be classified based on the messages of the users. For example, sentiments of the users are frequently expressed in friendly contexts: FACEBOOK, TWITTER can be a good source of information.

Relationships among users can be obtained in social media like FACEBOOK (friendship) or LINKED-IN (colleagues) more than looking at blog with specialized topics.

Data sources are accessed by users, topics and time to focus on the specific information that can help the system to solve issues, which is not a generic harvesting of data but the precise collection of data in a context defined by the system.

The system can actively use the data sources (e.g. social media) to post questions in order to solicit answers by users. The system may obtain potential solutions from skilled people, or measure the sentiment status of the users respect to a specific topic or issue, or classify the popularity of an issue or solution.

In step 209, the candidate solutions may be filtered and/or ranked based on matching the determined topic and the user's skill level related to the determined topic. For example, the solutions that correspond to the determined topic and correspond to the skill level of the user may be filtered and the filtered solution may be ranked (e.g. based on user ratings). If, for example, the skill level is an “expert” level in LINUX, and the determined topic is LINUX, the retrieved solutions can be filtered based on the source of the solution. The source of the solution may be suitable for the topic and the skill level (e.g. solutions from global blogs on software may be filtered out, while solutions form expert LINUX blogs may be maintained).

In an exemplary embodiment, the filtering of the candidate solutions comprises: deciding, using the information system, whether each of the candidate solutions has a positive or a negative sentiment; filtering candidate solutions having positive sentiments; and performing the ranking on the filtered candidate solutions. The sentiment analysis may enable to filter the convenient solution candidates. In an exemplary embodiment, the information system such as Blogs or Wiki may provide a rating mechanism that rates the solutions. These ratings may be used to filter the candidate solutions, which may help to reduce the amount of potential solutions to be classified by the system. For example, a blog such as STACKOVERFLOW, associates a question with a list of ordered answers produced by various users. The answers are ranked by the number of votes received, and/or by the reputation of the users who provided the answers. Candidate solutions provided by users having a low reputation may be filtered out or solutions having a number of votes below a predefined threshold may be filtered out.

The ranking of the solution may be performed after classifying the solutions in topics. The classification or ranking of the issues and the solutions in topics is performed using cognitive computing (e.g. Watson Analysis APIs) or manual classification.

For example, the rating of a solution may be expressed as an integer (0,100) based on the level of details of the solution or based on the quality of the solution (e.g. a solution may have a score of 20% good or 100% good). For the solutions stored in the local database of the help desk system 100, a rating mechanism available as product feature of the system may be used. For the solutions retrieved externally, the rating may be calculated by normalizing other score or rating programmatically available (through APIs or web crawling) or by using cognitive technologies to understand how widely it has been accepted and recognized as a good solution.

In one example, the candidate solutions found are merged into a unique result set ordered at first by rating R (between 0 and 100). The skill level of the user may be indicated by expertise ranking E by topic that can be expressed by an integer number in the same range of the one used for solution ranging (e.g. 0-100). If the user is expert in the topic, E=100%, if the user is knowledgeable in the topic E=60% etc. For example, a user may be rated 100 (or 100%) if the user is an expert in a given topic and the solution to a problem of the same user in the given topic may be classified 100 (or 100%) if the provided solution answers the user's question. For example, if the user is an expert, the user may require a very detailed solution or a very high quality solution for the user's problem or may require a solution provided by a person having similar skill of the user. A normal user may not need too technical details, and the user may need only a broad solution.

Thus, before presenting the set of solutions found to the user, the set of solutions is reshaped in order to have at the top the items that best match the user's expertise, using for example the following rule: ResultSet={[solutions with R=E+−10%], [solutions with R>E+10%], [all the other solutions found]}.

Upon receiving the ticket steps 203-209 may automatically be performed.

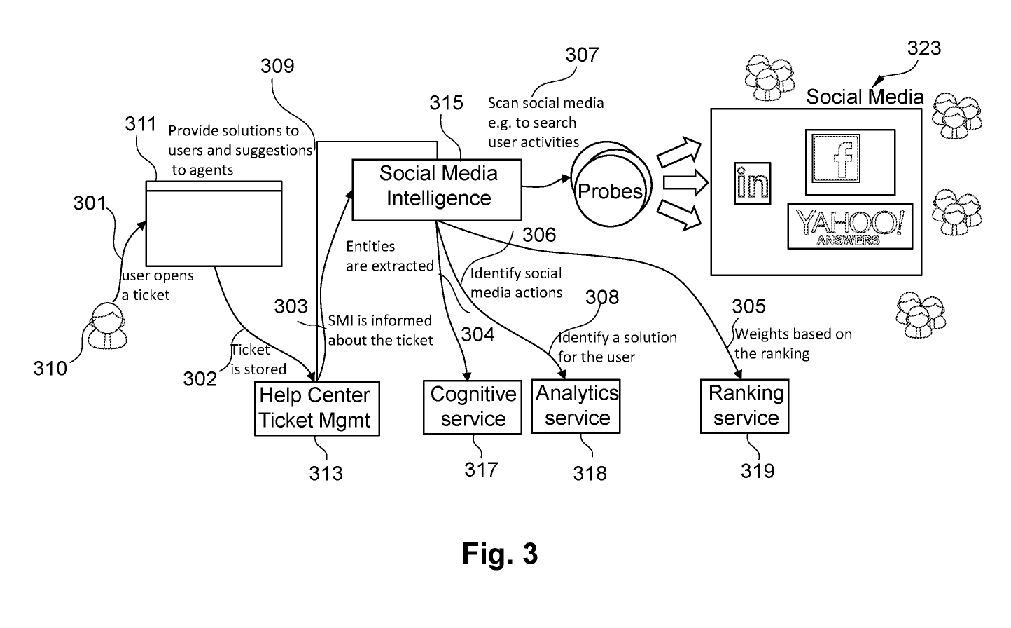

FIG. 3 depicts a block diagram of a method for processing a help desk ticket comprising a problem description, in accordance with embodiments of the present invention. For example, components 313, 315, 317, 318 and 319 may be part of the memory 110.

In step 301, a user 310 may open a ticket. The ticket may comprise a problem description. The ticket may be open via a graphical user interface 311. The graphical user interface 311 may be displayed at a client computer of the user 310.

In step 302, the help center ticket manager 313 may store the ticket in the help desk system 100.

In step 303, the help center ticket manager 313 informs a social media intelligence component 315 about the ticket and/or the user 310.

In step 304, social media intelligence component 315 may check or analyze the ticket to determine the problem description. For example, social media intelligence component 315 may define the elements of the problem using cognitive service 317. For example, the cognitive service 317 may be used to identify the context and/or topic of the problem of the ticket. The cognitive service may comprise IBM WATSON.

Once the cognitive service 317 is used to identify the context of the problem, a ranking may be associated in step 305 to the user 310 and to the problem itself. The ranking for the user 310 may be calculated with respect to the specific topic of the problem (e.g. using ranking service 319). The ranking of the user indicates the skill level of the user with regard to the context and/or the topic of the problem. The problem may be classified based on the user skill level to indicate the level of difficulty of the problem for the user. In other terms, the problem may be classified in terms of how much the problem is difficult with respect to the skill of the user 310.

In step 306, solutions for the problem may be searched in a local database of the help desk system 100 and a ranking of the locally available solutions may be determined with respect to the problem. In step 306, solutions that can be presented to the user 310 are evaluated by comparing the ranking of the user 310 and the solutions.

In response to determining that no solutions are locally found or that the ranked solutions do not match the user skill level, the social media intelligence component 315 is requested to provide solutions for the problem. The social media intelligence component 315 may connect in step 307 to the social media 323 such as FACEBOOK or TWITTER to request solutions for the problem.

In step 308, if new solutions are found by social media intelligence component 315 a new ranking may be applied to evaluate what solution to propose to the user 310 based on the skill level of the user 310. The solutions may be identified or determined using an analysis service 318. In step 309, the solutions may be provided to the user 310.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In one embodiment, the system of the present invention may be or include a hardware device such as a computer, portable device, etc. In one embodiment, the hardware device is or includes a special-purpose device (e.g., computer, machine, portable device) that comprises specialized, non-generic hardware and circuitry (i.e., specialized discrete non-generic analog, digital, and logic based circuitry) for (independently or in combination) particularized for executing only methods of the present invention. The specialized discrete non-generic analog, digital, and logic based circuitry may include proprietary specially designed components (e.g., a specialized integrated circuit, such as for example an Application Specific Integrated Circuit (ASIC), designed for only implementing methods of the present invention).

A computer program product of the present invention may include one or more computer readable hardware storage devices having computer readable program code stored therein, said program code containing instructions executable by one or more processors of a computing system (or computer system) to implement the methods of the present invention.

A computer system of the present invention may include one or more processors, one or more memories, and one or more computer readable hardware storage devices, said one or more hardware storage devices containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

What is claimed is:

1. A method for processing a help desk ticket comprising a problem description, the method comprising:
receiving, by a processor of a computing system, the help desk ticket submitted by a user of a help desk system;
determining, by the processor, a skill level of the user from user profile data accessible to the help desk system, the skill level describing the user's skill related to a predefined topic;
determining, by the processor, at least one topic based on the problem description;
retrieving, by the processor, a plurality of candidate solutions from at least one information system based on the problem description; and
filtering and/or ranking, by the processor, the plurality of candidate solutions based on matching the predefined topic and the skill level of the user.

2. The method of claim 1, wherein the at least one information system includes a local database of the help desk system and/or at least one social network.

3. The method of claim 1, wherein the retrieving of the plurality of candidates solutions comprises logging in to the at least one information system using a user account in the help desk system of the user.

4. The method of claim 1, further comprising reading, by the processor, the user profile data for identifying the at least one information system and performing the retrieving from the identified information system.

5. The method of claim 1, further comprising mapping, by the processor, multiple information systems with respective topics, and selecting, by the processor, the at least one information system based on the predefined topic using the mapping.

6. The method of claim 1, wherein the filtering and/or ranking of the plurality of candidate solutions comprises:
deciding, by the processor, using the at least one information system, whether each candidate solution of the plurality of candidate solutions has a positive or a negative sentiment;
filtering, by the processor, the plurality of candidate solutions having positive sentiments; and
performing, by the processor, the ranking on the filtered candidate solutions.

7. The method of claim 2, wherein the retrieving of the plurality of candidate solutions is performed from respective users of the social network, wherein the filtering and/or ranking of the plurality of candidate solutions is based on evaluated user skill levels at the social network of the users.

8. The method of claim 1, wherein the at least one information system includes a local database of the help desk system and/or at least one social network, the method further comprising:
ranking, by the processor, the at least one social network based on a number of user accounts in the at least one social network;
selecting, by the processor, a first ranked social network, wherein the retrieving is performed from the local database and/or the selected social network.

9. The method of claim 1, wherein the at least one information system includes at least one social network, the method further comprising:
evaluating, by the processor, a quality of at least one candidate solution of the plurality of candidate solutions; and
a result of the evaluating is that the quality is insufficient, then submitting, by the processor, a machine generated request comprising the problem description to a social network and retrieving, by the processor, a response to the request posted on the social network.

10. The method of claim 1, wherein the skill level of the user is further determined from information retrieved from at least one reputation system, from the at least one reputation system being an online forum where the user's skill related to the predefined topic is evaluated.

11. The method of claim 1, wherein the ranking of the candidate solution is performed using a ranking of the at least one information system.

12. A computer system comprising:
a processor;
a memory device coupled to the processor; and
a computer readable storage device coupled to the processor, wherein the storage device contains program code executable by the processor via the memory device to implement a method for processing a help desk ticket comprising a problem description, the method comprising:
receiving, by a processor of a computing system, the help desk ticket submitted by a user of a help desk system;
determining, by the processor, a skill level of the user from user profile data accessible to the help desk system, the skill level describing the user's skill related to a predefined topic;
determining, by the processor, at least one topic based on the problem description;
retrieving, by the processor, a plurality of candidate solutions from at least one information system based on the problem description; and
filtering and/or ranking, by the processor, the plurality of candidate solutions based on matching the predefined topic and the skill level of the user.

13. The computer system of claim 12, wherein the at least one information system includes a local database of the help desk system and/or at least one social network.

14. The computer system of claim 12, wherein the retrieving of the plurality of candidates solutions comprises logging in to the at least one information system using a user account in the help desk system of the user.

15. The computer system of claim 12, further comprising reading, by the processor, the user profile data for identifying the at least one information system and performing the retrieving from the identified information system.

16. The computer system of claim 12, further comprising mapping, by the processor, multiple information systems with respective topics, and selecting, by the processor, the at least one information system based on the predefined topic using the mapping.

17. A computer program product, comprising a computer readable hardware storage device storing a computer readable program code, the computer readable program code comprising an algorithm that when executed by a computer processor of a computing system implements a method for processing a help desk ticket comprising a problem description, the method comprising:
receiving, by a processor of a computing system, the help desk ticket submitted by a user of a help desk system;
determining, by the processor, a skill level of the user from user profile data accessible to the help desk system, the skill level describing the user's skill related to a predefined topic;
determining, by the processor, at least one topic based on the problem description;
retrieving, by the processor, a plurality of candidate solutions from at least one information system based on the problem description; and
filtering and/or ranking, by the processor, the plurality of candidate solutions based on matching the predefined topic and the skill level of the user.

18. The computer program product of claim 17, wherein the at least one information system includes a local database of the help desk system and/or at least one social network.

19. The computer program product of claim 17, wherein the retrieving of the plurality of candidates solutions comprises logging in to the at least one information system using a user account in the help desk system of the user.

20. The computer program product of claim 17, further comprising reading, by the processor, the user profile data for identifying the at least one information system and performing the retrieving from the identified information system.
